(19) United States
(12) Patent Application Publication
(10) Pub. No.: US 2013/0233177 A1
(43) Pub. Date: Sep. 12, 2013

(54) Single Cup Coffee and Tea Brewing Mug

(71) Applicant: David Lambert, Memphis, TN (US)

(72) Inventor: David Lambert, Memphis, TN (US)

(21) Appl. No.: 13/775,101

(22) Filed: Feb. 22, 2013

Related U.S. Application Data
(60) Provisional application No. 61/602,078, filed on Feb. 22, 2012.

(51) Int. Cl. A47J 31/40

(52) U.S. Cl. CPC A47J 31/407
USPC 99/295

(57) ABSTRACT

A single serving filter pod encapsulated brewing press and thermal drinking receptacle allowing a user to brew coffee or tea within the device using premeasured sealed filter pods.

### CROSS-REFERENCE TO RELATED APPLICATIONS

This application claims the benefit of U.S. Provisional Application No. 61/602,078, filed Feb. 22, 2012.

### BACKGROUND OF THE INVENTION

The present invention relates to single serve brewing devices, particularly to single serve brewing devices for use with encapsulated brewing pods, such as used to brew coffee, tea or the like. Traditional single serve brewing mugs are designed for use with loose coffee or tea. Such systems create uneven brewing and can be difficult to setup, and messy to clean up. Coffee pods simplify individual beverage brewing by pre-measuring the beverage grounds within a porous filter paper that can be easily and neatly disposed of when complete. Coffee pods, however, require water to be forced directly through the pod. Traditional coffee presses, allow the water to bypass the pod contents, and instead brew an inconsistent or weak beverage.

### BRIEF SUMMARY OF THE INVENTION

The present invention allows a user to brew a single serving of their choice of beverage in a container that also doubles as a drinking receptacle. The invention is designed such that once brewing is complete, the ground coffee or tea may be left within the device until the beverage is consumed without significant alteration in taste of the beverage during consumption.

To use the invention, the operator places a beverage pod, such as a coffee pod, inside the pod retainer. The pod retainer is secured to the inner brew chamber. Hot water is poured into the outer brew chamber and the inner brew chamber is placed on top with the pod retainer down. The inner brew chamber is pressed down into the hot water and outer brew chamber. Gaskets, both inside the brew retainer and around the inner brew chamber force the water through the pod. Brewed beverage fills the inner brew chamber. When the inner brew chamber is fully seated within the outer brew chamber, the brewing cycle is complete and the beverage may be enjoyed. In at least one embodiment, the inner and outer brew chambers form a double walled receptacle having increase insulating properties for helping to maintain the desired drinking temperature.

Upon completion of the beverage, the user may separate the inner and outer brewing chambers, unfasten the pod retainer and discard the pod.

### BRIEF DESCRIPTION OF THE DRAWINGS

The invention is illustrated by the accompanying drawings, in which:

FIG. 1A is a side perspective view of the invention showing the inner brew chamber in a raised position.

FIG. 1B is a side perspective view of the invention showing the inner brew chamber in an intermediate position.

FIG. 1C is a side perspective view of the invention showing the inner brew chamber in a lowered position.

FIG. 1D is a side perspective view of the invention.

FIG. 1E is a sectional view of the invention in FIG. 1D taken on section line 1E-1E.

FIG. 2A is an exploded side perspective view of the inner brew chamber.

FIG. 2B is a side perspective view of the inner brew chamber.

FIG. 3A is an exploded side perspective view of an alternative embodiment of the inner brew chamber.

FIG. 3B is a side perspective view of an alternative embodiment of the inner brew chamber.

FIG. 4A is a bottom view of the pod retainer.

FIG. 4B is a perspective view of the pod retainer.

FIG. 4C is a top view of the pod retainer.

FIG. 5A is a side view of the inner brew chamber in an unassembled state.

FIG. 5B is a side perspective view of the inner brew chamber.

FIG. 6A is a side view of a typical coffee pod.

FIG. 6B is a bottom view of a typical coffee pod.

FIG. 7A is a perspective side view of the outer brew chamber.

FIG. 7B is a perspective side view of the invention showing the inner brew chamber in dotted lines.

FIG. 8 shows a top view of a first embodiment of a brew screen.

FIG. 9A shows a top view of a strength adjustment disk of a second embodiment of the brew screen.

FIG. 9B shows a top view of the outer brew screen portion of the second embodiment of the brew screen.

FIG. 10A shows a perspective view of the second embodiment of the brew screen unassembled.

FIG. 10B shows a perspective view of the second embodiment of the brew screen assembled.

FIG. 11A shows a top view of the second embodiment of the brew screen with the apertures aligned for full brew strength.

FIG. 11B shows a top view of the second embodiment of the brew screen with the small and large apertures aligned for reduced brew strength.

FIG. 12 shows a cross section of the second embodiment of the brew screen taken on line 12-12 of FIG. 11A.

### DETAILED DESCRIPTION OF THE INVENTION

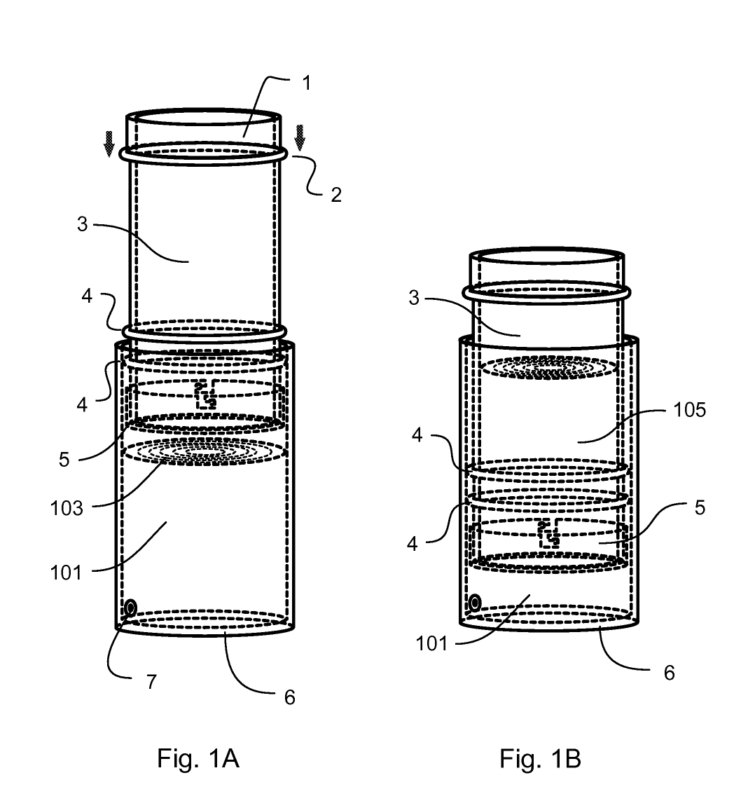

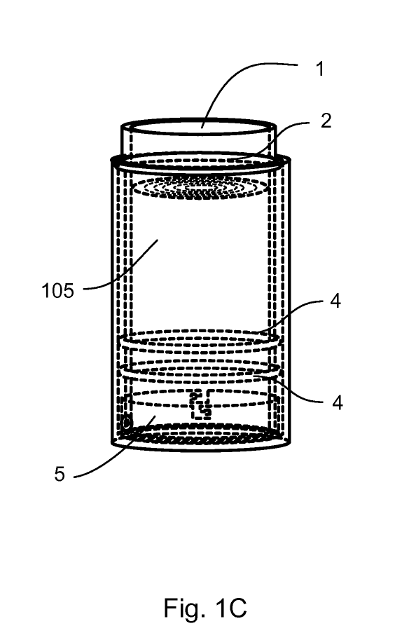

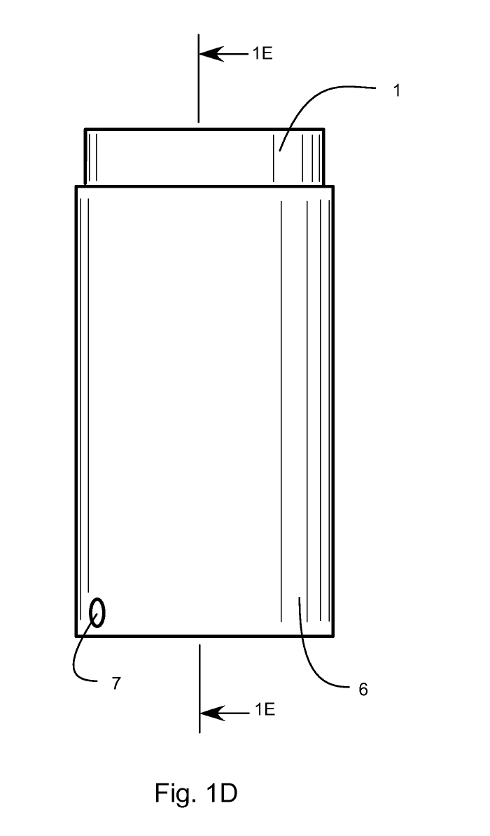

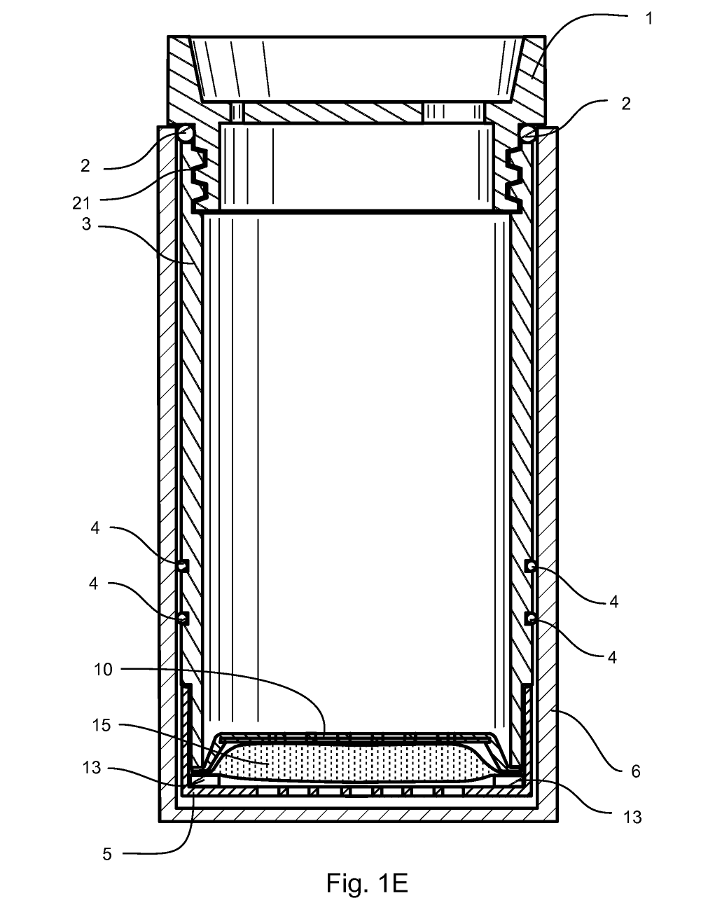

FIG. 1 shows the operation of the single cup beverage pod press. For the purpose of this illustration, the outer brew chamber 6 is transparent to allow viewing of the inner brew chamber 3. FIG. 1A shows the outer brew chamber 6 filled with liquid 101 of an appropriate temperature for brewing the beverage, such as hot water. The outer brew chamber 6 is a generally cylindrical shape with an open top and a closed bottom, having a bottom and a side wall. A release valve 7 may be located in the bottom portion of the outer brew chamber 6. The beverage pod, such as a coffee pod shown herein, located within the pod retainer 5 at the lower end of the brew chamber 3 is pressed downward by the operator. FIG. 1B shows the inner brew chamber 3 in an intermediate position as the water 101 perfuses through the coffee pod. As the inner brew chamber 3 is forced down below the liquid surface 103, it fills with brewed coffee 105. O-ring seals 4 prevent the water 101 from exiting the outer brew chamber 6. FIG. 1C shows the completed brew cycle, with the inner brew chamber 3 fully down within the outer brew chamber 6. The area between the vertical walls of the inner brew chamber 3 and vertical walls of the outer brew chamber 6 remains relatively free of liquid, providing additional insulation to the container. A lid 1 provides additional thermal insulation and/or spill resistance. The lid 1 may have one or more apertures for liquid and air to ingress and egress from the inner brew chamber 3. A lid gasket 2 seals against the upper portion of the outer brew chamber 6 such that when the unit is assembled, the lid gasket maintains an airtight seal against the outer brew chamber creating a thermal travel container. When the inner chamber 3 is down in the lowest most position within the outer chamber 6, the beverage pod within the pod retainer 5 is seated near the bottom of the brew chamber, minimizing circulation, or continued brewing of the beverage 105.

FIG. 1D shows a side view of the single cup pod press and beverage container showing the lid 1 and outer brew chamber 6 with release valve 7. The release valve 7 enables the inner brew chamber 3 to be more easily pulled from the outer brew chamber 6 by allowing air to pass through the outer brew chamber, reducing the vacuum.

FIG. 1E shows a section view of the invention in FIG. 1D taken on section line 1E-1E. The inner brew chamber 3 fits within the outer brew chamber 6. Seals 4 are disposed upon the outer wall of the inner brew chamber 3 and seal against the inner wall surface of the outer brew chamber 6. Seals 4 prevent egress of water between the walls the inner and outer brew chambers 3, 6. Lid 1 is shown secured to the inner brew chamber with threaded connection 21. Lid gasket 2 seal against the lid 1 and outer brew chamber 6. Ideally lid gasket 2 provides an air tight sealed cavity adding to the thermal insulating properties of the invention to maintain the beverage's temperature. The pod 15 is placed between the brew screen 10 and pod retainer 5. A seal 13 tightly presses against the pod flange preventing water from bypassing the pod's contents ensuring an even consistent brew.

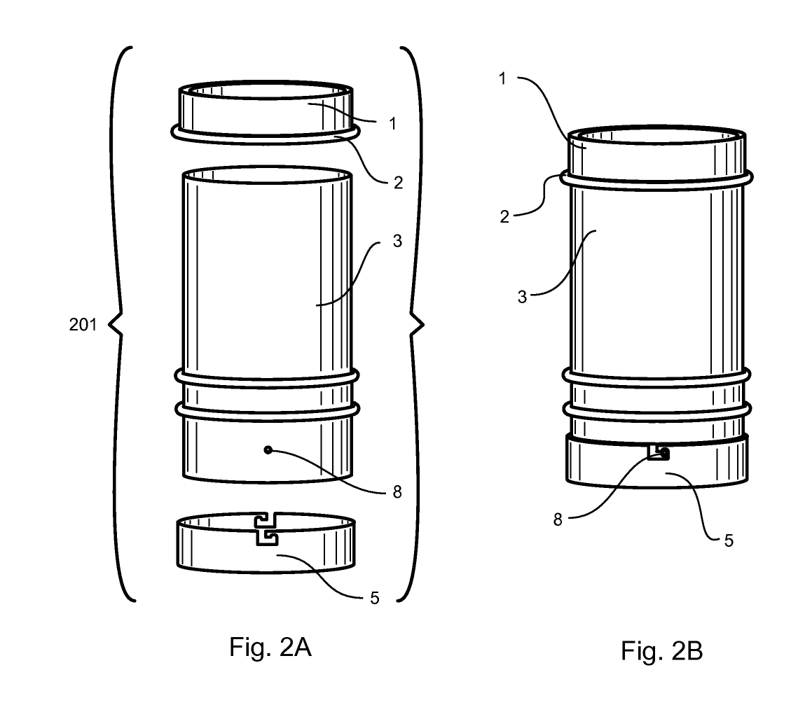

FIG. 2A shows the inner brew chamber 3, lid 1, and pod retainer 5, in a disassembled state 201. In the present invention, the pod retainer 5 is retained to the inner brew chamber 3 by a plurality of retainer lock pins 8. A lid gasket 2 is shown attached to the lid 1. FIG. 2B shows the inner brew chamber 3, lid 1 and pod retainer 5 assembled.

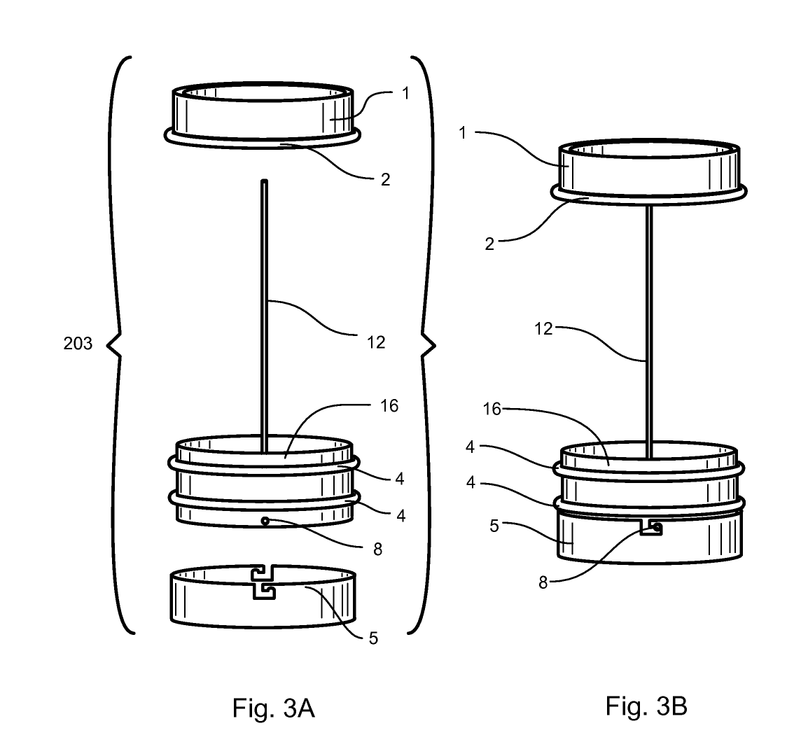

FIGS. 3A and 3B shows an alternative embodiment to the inner brew chamber. Instead of a long inner brew chamber 3, a short inner brew chamber or “brew piston” 16 is attached to the lid 1 by a rod or brew shaft 12. In this alternative embodiment, the pressing on the lid 1 transfers the downward force to the lower brew piston 16 lowering the inner brew assembly into the outer brew chamber 6 forcing the water through the pod. FIG. 3A shows the lid 1, brew rod 12, brew piston 16 and pod retainer 5 in a disassembled state 203, while FIG. 3B shows the same components in an assembled state.

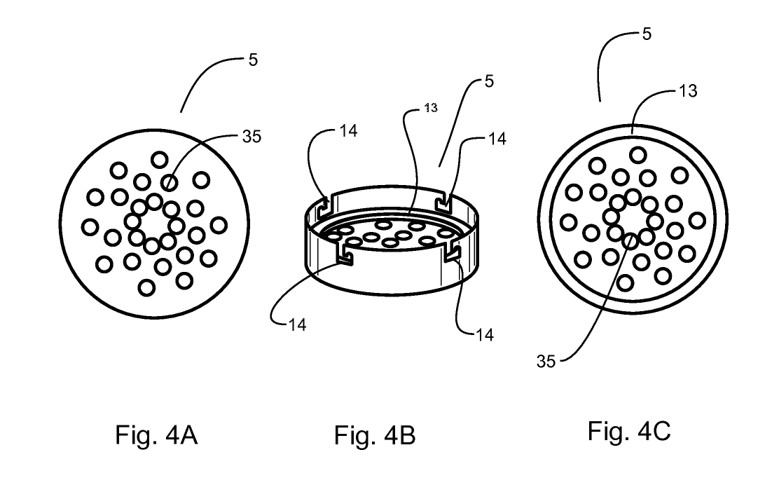

FIG. 4A shows a bottom view of the pod retainer showing a plurality of apertures 35 through which water can pass allowing brewing of the pod beverage. FIG. 4B shows a side perspective view showing the retainer gasket 13. The retainer gasket 13 seals against the pod flange, pod retainer 5 and lower portion of the inner brew chamber 3 or brew piston 16, preventing water from bypassing the contents of the pod. A plurality of retainer locks 14 engage the retainer lock pins 8 to secure the pod retainer 5 to the brew piston 16 or inner brew chamber 3. FIG. 4C shows a top view of the pod retainer.

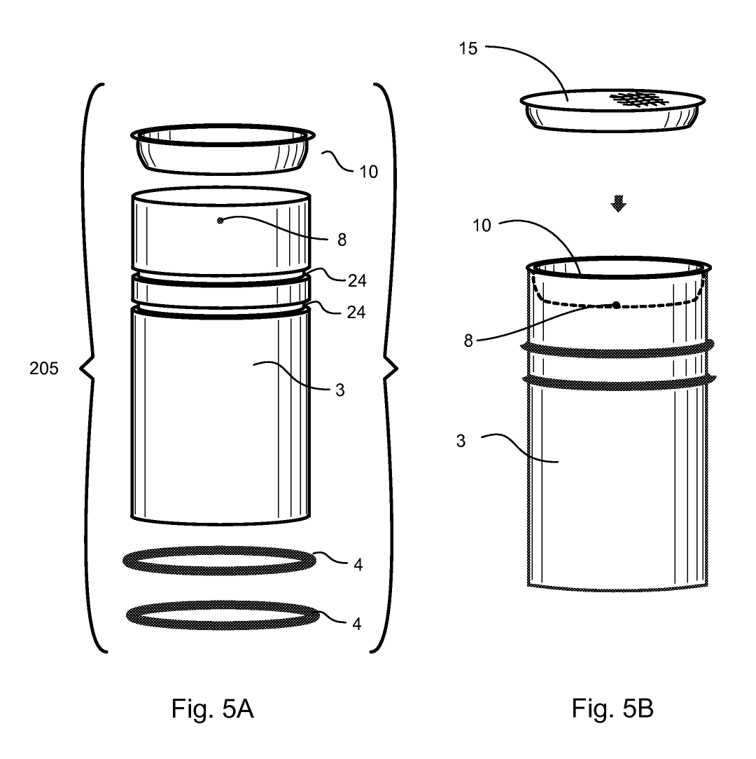

FIG. 5A shows a side view of the inner brew chamber 3 inverted and in an unassembled state 205. A brew screen 10 retains the pod and prevents the pod 15 from entering the inner brew chamber. The brew chamber gaskets 4 are retained by the inner brew chamber 3 by seating in retaining grooves 24 which may be present to assist in securing the brew chamber gaskets. FIG. 5B shows a side perspective view of the inner brew chamber 3, brew screen 10, and pod 15.

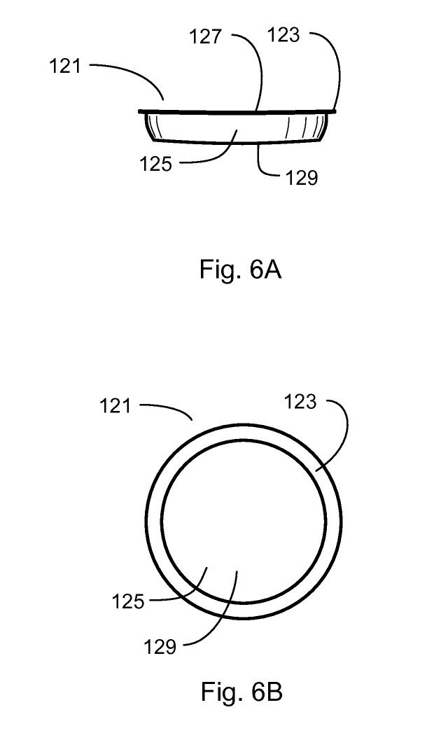

FIG. 6A shows a side view of a standard coffee pod 15 and its circumferential flange 121. The pod contains the product desired to be brewed between two layers of porous material. This portion containing the brew product is referred to as the pod belly 125. The pod flange 123 surrounds the pod belly 125 and provides an area where the top layer 127 is attached to the bottom layer 129. FIG. 6B shows a bottom view of the same coffee pod 15. The pod 15 generally is comprised of an upper sheet and a lower sheet of porous media joined at a circumferential flange and containing ground coffee, tea leaves or the like for brewing.

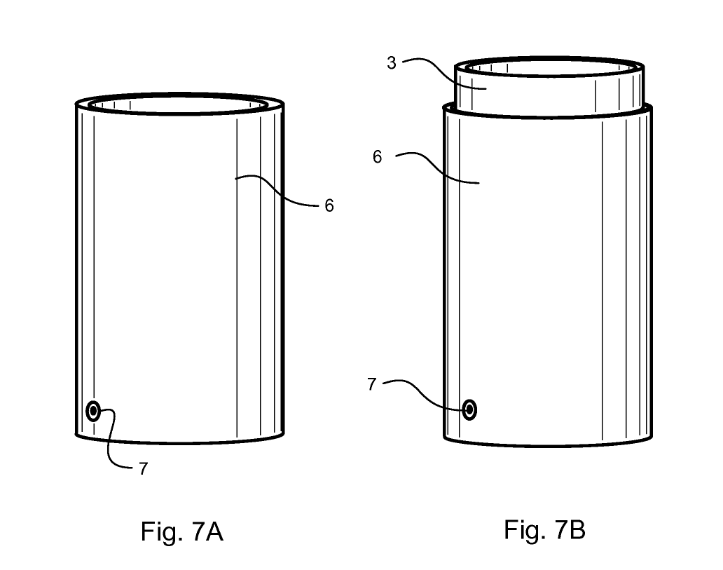

FIG. 7A shows a perspective view of the outer brew chamber 6. FIG. 7B shows the outer brew chamber 6 assembled with the inner brew chamber 3, lid 1 and pod retainer 5. A release valve 7 positioned in the lower portion of the outer brew chamber 6 allows air to ingress into the outer brew chamber 6 when the inner brew chamber 3 is removed from the outer brew chamber 6.

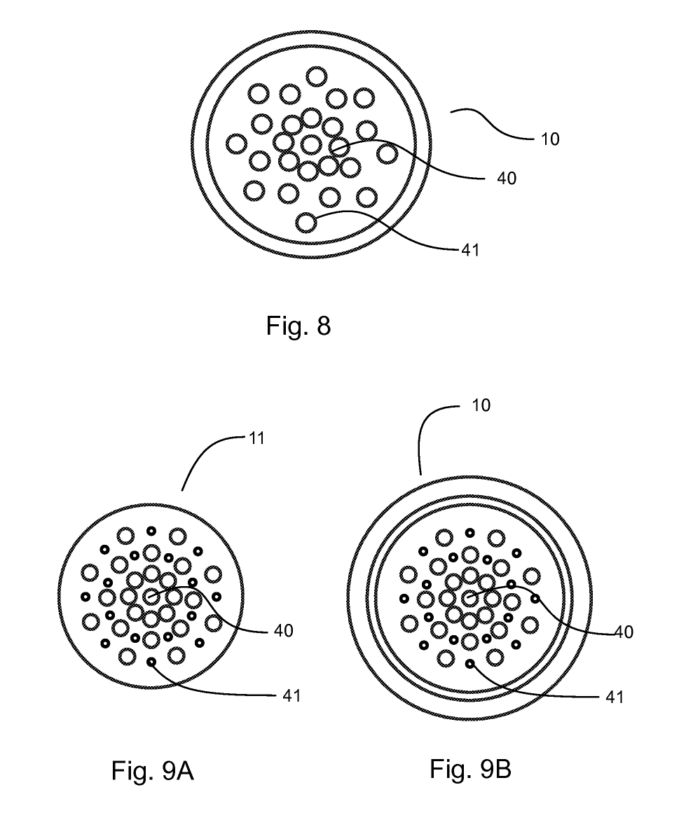

FIG. 8 shows a bottom view of a first embodiment of the brew screen 10. The brew screen possesses large apertures 40 and small apertures 41. The smaller apertures 41 restrict fluid flow forcing most of the liquid through the large apertures 40 and adjacent pod contents, thus resulting in a milder brewed beverage. Alternatively, the apertures may be the same size or more or less numerous to produce the desired brew strength.

FIG. 9 shows an alternative second embodiment of the brew screen. FIG. 9A shows a strength adjustment disk 11 having a radial pattern of apertures 40, 41. FIG. 9B shows the outer brew screen 30 with a corresponding plurality of apertures 40, 41.

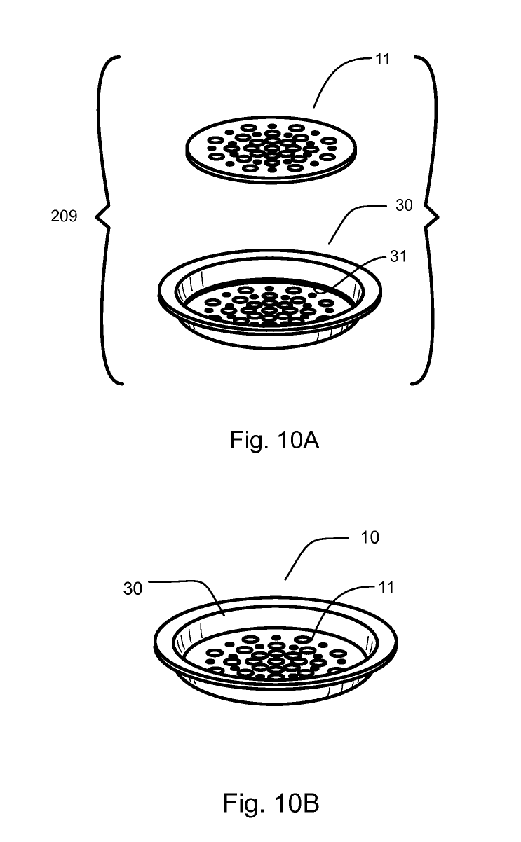

FIG. 10 A shows the strength adjustment disk 11 and outer brew screen 30 in an unassembled state 209. The strength adjustment brew screen 11 may be retained by the outer brew screen 30 by a retainer groove 31. FIG. 10B shows the strength adjustment disk 11 and outer brew screen 30 assembled as a brew screen unit 10. It should be understood that while a retainer groove 31 is shown as retaining the brew strength adjustment disk, the disk may be retained by a central pivot such as a rivet, crimp or divot.

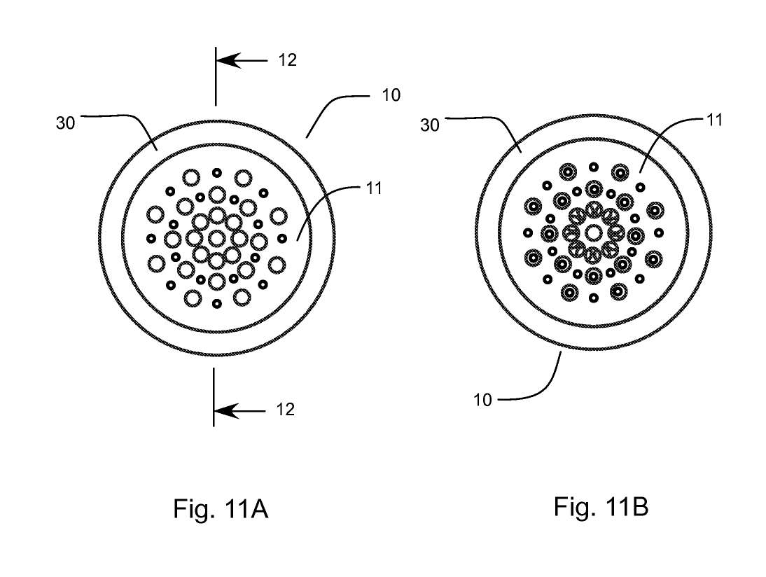

FIG. 11A shows a top view of the brew screen 10 with the strength adjustment disk 11 and outer brew screen 30 aligned for full brew strength. Rotating the strength adjustment disk 11 as shown in FIG. 11B allows the large apertures to be either completely or partially covered, or aligned with the small apertures in the outer portion of the brew screen 10 while providing ample area for liquid to flow through the center portion of the pod. The strength adjustment disk 11 allows the user to select a achieve a desired brew strength by varying the flow rate of the liquid across different areas of the brew pod. For instance, a brew strength adjustment disk 11 set to allow flow across the entire pod surface would result in a stronger brew, while closing the apertures closer to the circumference would force a larger portion of the liquid through the center of the disk, resulting in a weaker brew.

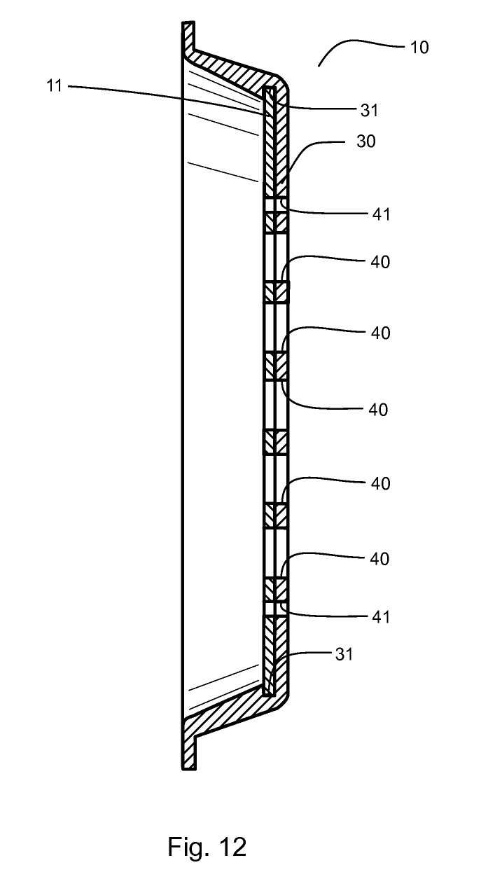

FIG. 12 is a cross section of the brew screen showing the large apertures 40 and small apertures 41 aligned for full brew strength. The inner brew screen 11 is retained by the strength adjustment disk retainer groove 31.

What is claimed is:

1. A beverage brewing apparatus for brewing using a filter pod having an outer circumferential flange, said apparatus comprising:
an outer brew chamber having a sidewall, an open top and a bottom wall opposite the open top;
an inner brew chamber having an open top, a sidewall, a brew screen, and a first seal, said first seal disposed upon the outer surface of said sidewall of said inner brew chamber, said first seal engaging the inner surface of said sidewall of said outer brewing chamber, forming a seal between said outer brew chamber and said inner brew chamber, while allowing said inner brew chamber to move within said outer brew chamber;
wherein said brew screen is positioned at the bottom of said inner brew chamber opposite said open top, said brew screen having at least one aperture;
a pod retainer having at least one aperture, said pod retainer releasably attached to said inner brew chamber;
wherein said circumferential flange of said pod is sealed between said pod retainer and said inner brew chamber; and
a lid having an aperture, the lid being removably secured to the top of one of said inner brew chamber or said outer brew chamber to close said apparatus.

2. The apparatus of claim 1 wherein said pod retainer is further comprised of an annular gasket, where said circumferential flange of said pod is pinched between said gasket and said inner brew chamber.

3. The apparatus of claim 2 wherein said circumferential pod flange is disposed between said gasket and said brew screen.

4. The apparatus of claim 1 wherein said brew screen is comprised of a first brew screen possessing a plurality of apertures and a second brew screen possessing a plurality of apertures, whereas the apertures of said first brew screen can be selectively aligned with the apertures of said second brew screen so as to increase or decrease flow rates across selected portions of said pod thereby adjusting the brew strength of the beverage.

5. A beverage brewing apparatus for brewing using a filter pod having an outer circumferential flange, said apparatus comprising:
an outer brew chamber having a sidewall, an open top and a bottom wall opposite the open top;
an inner brew chamber having an open top, a sidewall, a brew screen, and a first seal, said first seal disposed upon the outer surface of said sidewall of said inner brew chamber, said first seal engaging the inner surface of said sidewall of said outer brew chamber, forming a seal between said outer brew chamber and said inner brew chamber, while allowing said inner brew chamber to move within said outer brew chamber;
wherein said brew screen is positioned at the bottom of said inner brew chamber opposite to said open top, said brew screen having at least one aperture;
a pod retainer having at least one aperture said pod retainer releasably attached to said inner brew chamber;
wherein said circumferential flange of said pod is sealed between said pod retainer and said inner brew chamber; and
a lid having an aperture, the lid being removably secured to the top of one of said inner brew chamber or said outer brew chamber to close said apparatus;
wherein said brew screen is comprised of a first brew screen possessing a plurality of apertures and a second brew screen possessing a plurality of apertures, whereas the apertures of said first brew screen can be selectively aligned with the apertures of said second brew screen so as to increase or decrease the flow rates across selected portions of said pod thereby adjusting the brew strength of the beverage.

6. The apparatus of claim 5 wherein said pod retainer is further comprised of an annular gasket, where said circumferential flange of said pod is pinched between said gasket and said inner brew chamber.

7. The apparatus of claim 5 wherein said circumferential pod flange is disposed between said gasket and said brew screen.

8. A beverage brewing receptacle for brewing beverage pods comprising:
an outer brew chamber having a sidewall, an open top and a bottom wall opposite said open top;
a brew screen assembly comprising a first brew screen and a second brew screen;
said first brew screen possessing a plurality of apertures;
said second brew screen possessing a plurality of apertures adjacent to said first brew screen, whereas the apertures of said first brew screen can be selectively aligned with the apertures of said second brew screen so as to increase or decrease the flow rates across selected portions of said pod thereby adjusting the brew strength of the beverage;
a seal positioned between the outer circumference of said brew screen assembly and the inner surface of said outer brew chamber sidewall;
A pod retainer, said pod retainer sealing the circumference of said beverage pod to the outer circumference of said brew screen assembly; and
a lid possessing at least one aperture for the egress of beverage from said receptacle.
